(19) United States
(12) Patent Application Publication
(10) Pub. No.: US 2016/0214838 A1
(43) Pub. Date: Jul. 28, 2016

(54) Specialized Lifting Strap

(71) Applicant: Daniel McCoy, Plumerville, AR (US)

(72) Inventor: Daniel McCoy, Plumerville, AR (US)

(21) Appl. No.: 14/606,147

(22) Filed: Jan. 27, 2015

(51) Int. Cl. B66C 1/12

(52) U.S. Cl. CPC B66C 1/12

(57) ABSTRACT

A specialized lifting strap designed to conform to the shape of the object being lifted. The lifting strap utilizes on or more strap elements which wrap, wholly or in part, around the object to be lifted and handles which the lifter may use to grip and apply lifting force to the object via the lifting strap.

### BACKGROUND OF THE INVENTION

The present invention is in the technical field of lifting straps. More particularly, the present invention is in the technical field of lifting straps which adjust in size to accommodate the thing which is being lifted.

Conventional lifting straps and slings do not adjust or conform to the object being lifted. While these methods can provide acceptable results, existing devices present drawbacks such as the inability to be used on particular objects as well as a hazard of dropping due to the inability to adjust to the size of a given object.

### SUMMARY OF THE INVENTION

The present invention is a lifting strap designed to adjust to the size and shape of the object being lifted through the use of fasteners to form attach the strap to itself such that it surrounds the object being lifted as well as fasteners which attach the strap to the object being lifted.

The advantages of the present invention include, without limitation, that it is relatively simple in mechanical operation and it is substantially safer than conventional devices. The use of fasteners to surround the object with the strap or attach the strap to the object allows the object to be lifted to be securely held by the strap and the lifter which reduces the risk of the object being dropped and damaging the object or injuring the lifter.

### BRIEF DESCRIPTION OF THE DRAWINGS

These and other features, aspects, and advantages of the present invention will become better understood with regard to the following description, claims, and accompanying drawings where:

FIG. 1 is an upper perspective view of a first embodiment of a specialized lifting strap;

FIG. 2 is a lower perspective view of a first embodiment of a specialized lifting strap;

FIG. 3 is a perspective view of a second embodiment of a specialized lifting strap;

### DETAILED DESCRIPTION OF THE INVENTION

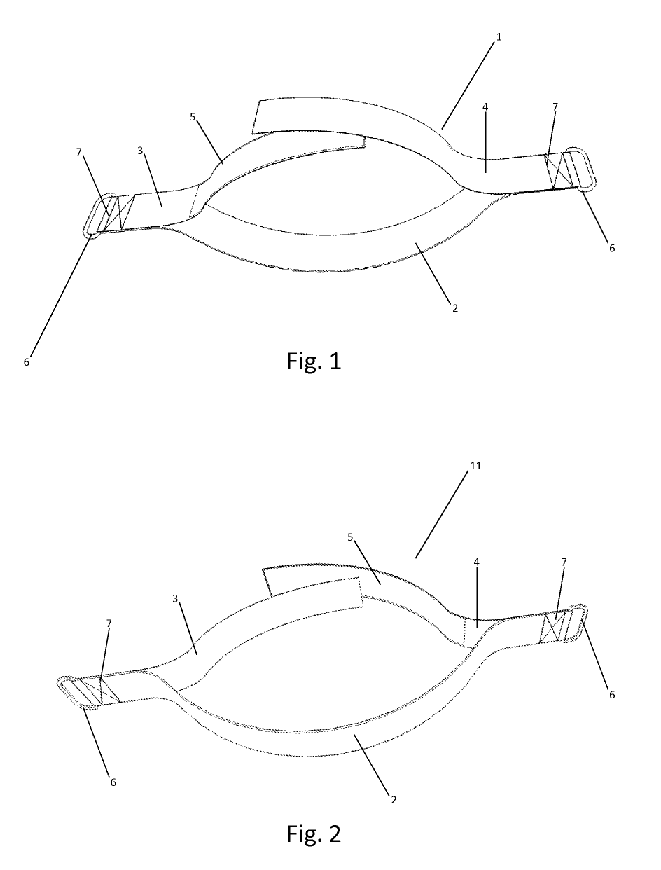

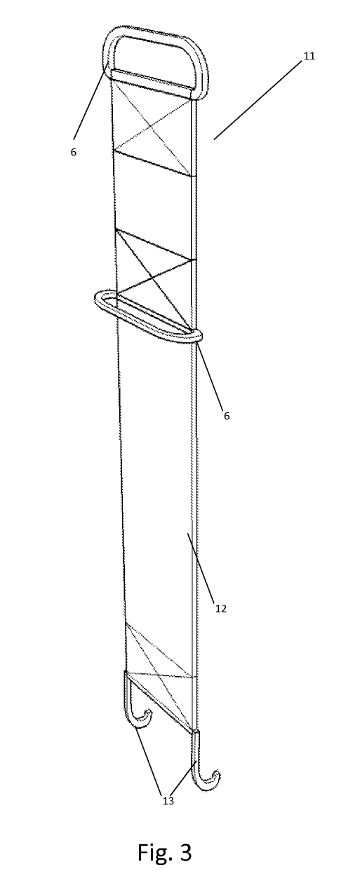

Referring to the drawings, FIGS. 1 and 2 depict a first embodiment of a specialized lifting strap 1 having a lower strap element 2, a first upper strap element 3, a second upper strap element 4, an upper strap fastener 5, and handles 6. The lifting strap 1 may also include reinforcements sections 7 to increase the strength of the lifting strap 1.

The first embodiment of a specialized lifting strap 1 has a lower strap element 2 which may be made of leather, fabric, woven webbing material, rubber or other durable, flexible material with the preferred material being a woven nylon material. This embodiment 1 also includes a first upper strap element 3 and a second upper strap element 4 which may be made of the same materials as the lower strap element 2. The first upper strap element 3 and the second upper strap element 4 may be continuous with the lower strap element 1 of they may consist of separate pieces.

The first embodiment of a specialized lifting strap 1 also has an upper strap fastener 5 for securing the first upper strap element 3 to the second upper strap element 4. The fastener is configured to be adjustable such that the upper strap elements may be affixed together with varying amounts of overlap such that the lifting strap 1 may be tightened or loosened to conform to an object. The upper strap fastener 5 is preferably a hook and loop style fastener, but may also be an adjustable buckle, rings, hooks, pins or other fasteners which allow an adjustable attachment of the first upper strap element 3 to the second upper strap element 4.

The first embodiment of a specialized lifting strap 1 also features multiple handles 6. The handles are attached to the strap elements such that one handle is attached to one end of the the lower strap element 2 and the first upper strap element 3 and a second handle is attached to the second end of the lower strap element 2 and the second upper strap element. The arrangement of the handles 6 with respect to the strap element is best seen in FIGS. 1 and 2. The handles 6 may be made of metal, plastic, composite material, leather, fabric, woven webbing material, rubber or other durable, flexible material. The handles preferably take the form of a ring shape with flattened sides but may also have a rectangular, circular or T shape.

To operate the first embodiment of the specialized lifting strap 1, the lower strap element 2 is placed under the object to be lifted and oriented such that the lower strap element 2 is matched to the contour of the object such that the lower strap element 2 cradles the bottom and potentially the sides of the object. The first upper strap element 3 is then placed against the sides of the object and positions such that it rests against the sides and top of the object. The second strap element 4 is positioned in a similar manner as the first upper strap element 3 and is placed where it will overlap the upper strap element 3 along the top of the object. The fastener 5 is then used to secure the first upper strap element 3 to the second upper strap element 4 in such a manner as to fit the lifting strap 1 securely and snugly around the object. When the strap 1 attached to the object, the handles 6 should be oriented along the sides of the object such that the user may then lift the object.

The second embodiment of a specialized lifting strap 11 has a single strap element 12 which may be made of leather, fabric, woven webbing material, rubber or other durable, flexible material with the preferred material being a woven nylon material.

The second embodiment of a specialized lifting strap 11 also features multiple handles 6. The handles are attached to the strap elements such that one handle is attached to the first end of the strap element 12 and subsequent handles are positioned partway between the two ends of the strap element 12. The arrangement of the handles 6 with respect to the strap element 12 is best seen in FIG. ______. The handles 6 may be made of metal, plastic, composite material, leather, fabric, woven webbing material, rubber or other durable, flexible material. The handles preferably take the form of a ring shape with flattened sides but may also have a rectangular, circular or T shape. The second embodiment also features and object attachment point 13 located at and attached to the second end of the strap element 12. The attachment point 13 is preferably configured as parallel J-hooks spaced the width of the strap element 12 apart. The attachment point 13 may also be configured as a single hook, multiple hook as well as have a polygonal shape rather than a rounded shape and may or may not be equipped with clips which prevent the attachment point 13 from coming loose from the object.

The second embodiment of the specialized lifting strap 11 is configured to lift objects which have fallen over back into an upright position. To use the second embodiment 12, the attachment point 13 is attached to the object in a position which is low on the object and on the underside of the fallen object such that the strap 11 is situated on the underside of the fallen object. The user will then position him or herself near the attachment point 13 such that he or she will have to reach over the object to grip the handles 6. The user will then grip both handles and pull up and toward him or herself such that the object pivots on the ground approximately where the attachment point 13 is connected to the object. The user continues to pull the handles until the object is upright and can be braced or otherwise stand on its own.

While this invention has been described with the specific embodiments outlines above, the preferred embodiments set forth are intended to be illustrative, not limiting. Various changes may be made without departing from the scope of the invention as defined in the following claims. The claims provide the scope of coverage of this invention and should not be limited to the specific examples cited above.

What is claimed is:

1. A lifting strap configured to conform to the shape of an object being lifted comprising:
a lower strap element, a first upper strap element and a second upper strap element;
two handles, the first said handle being attached to a first end of the lower strap element and an end of the first upper strap element, and the second said handle being attached to a second end of the lower strap element and an end of the second upper strap element; and
a fastener configured to attach the first upper strap element to the second upper strap element and configured such that the attachment of said first and second upper strap elements is adjustable with respect to degree of overlap of said first and second upper strap elements.
said strap configured such that the lower strap element may be physically separated from the fastened upper strap elements throughout the span between the first and second ends so as to allow a void between the upper and lower strap elements into which object to be lifted may be placed.

2. A lifting strap configured to lift fallen objects comprising:
a single strap element;
a plurality of handles, a first handle being the first said handle being attached in a fixed position to a first end of the strap element and the remaining handles being attached to the strap in fixed positions located between the first end of the strap element and a second end of the strap element such that no handles are immediately proximate one another nor immediately proximate said first or second ends of the strap element; and
an object attachment point to be affixed to an object being lifted attached in a fixed position to the second end of the strap element.

3. A lifting strap according to claim 1 wherein the fastener is a hook and loop fastener.

4. A lifting strap according to claim 1 wherein the handles are not slidable on the strap element.

5. A lifting strap according to claim 2 wherein the object attachment point is one or more hooks.

6. A lifting strap according to claim 2 wherein the handles are not slidable on the strap element
